(19) United States
(12) Patent Application Publication
(10) Pub. No.: US 2022/0186777 A1
(43) Pub. Date: Jun. 16, 2022

(54) TAPERED ROLLER BEARING

(71) Applicant: Schaeffler Technologies AG & Co. KG, Herzogenaurach (DE)

(72) Inventors: Jens FELLA, Gochsheim (DE); Igor GÜNTHER, Bad Kissingen (DE)

(73) Assignee: Schaeffler Technologies AG & Co. KG, Herzogenaurach (DE)

(21) Appl. No.: 17/603,058

(22) PCT Filed: Mar. 20, 2020
(86) PCT No.: PCT/DE2020/100222

§ 371 Date: Oct. 12, 2021

(30) Foreign Application Priority Data
Apr. 18, 2019 (DE) 10 2019 110 299.5

(51) Int. Cl. F16C 19/36

(52) U.S. Cl. CPC F16C 19/364; F16C 2322/39; F16C 2240/70

(57) ABSTRACT

A tapered roller bearing (1) is provided including an inner ring (2) having an inner ring raceway (3), an outer ring (4) having an outer ring raceway (5), and tapered rollers (6) rolling on the raceways (3, 5). This tapered roller bearing (1) is characterized in that the nominal contact angle (a) thereof is between 20°-30°, and the tapered rollers (6) have a ratio of rolling element length (L) to rolling element diameter (Dw) of 1.0-1.2.

### CROSS-REFERENCE TO RELATED APPLICATIONS

This application is the U.S. National Phase of PCT Appln. No. PCT/DE2020/100222, filed Mar. 20, 2020, which claims priority to German Patent Application No. 10 2019 110 299.5, filed Apr. 18, 2019, the entire disclosures of which are incorporated by reference herein.

### TECHNICAL FIELD

The disclosure relates to a tapered roller bearing, comprising an inner ring with an inner ring raceway, an outer ring with an outer ring raceway, and tapered rollers rolling on the raceways.

### BACKGROUND

The constant further development in materials technology as well as the use of high-strength materials, for example in the automotive and aerospace industries, place the highest demands on the machine tools used to machine such materials with regard to the bearings of the machine tool spindles. This is often associated with an increase in cutting speed and the trend towards high-volume machining. In order to meet these challenges, high-performance spindle bearing systems are required that have an optimal ratio between high load-bearing capacity, high rigidity, and the best speed suitability. For this purpose, due to their good speed suitability, high-precision angular contact ball bearings are usually used, which are installed in pairs in an X or O arrangement depending on the operating conditions. Depending on the application, these can be designed with light, medium or heavy bias. Tool spindles with high demands on rigidity are realized by contiguous placement of any number of spindle bearings, for example four or six spindle bearings in a tandem-O-tandem arrangement.

Due to the rigid placement and the multiple arrangement as well as the choice of an increased bias class, however, the speed suitability of a spindle bearing consisting of any number of spindle bearings can vary greatly. This means that the actual speed limit based on the calculated, nominal speed limit of the individual angular contact ball bearings is significantly reduced, for example in the case of an O-arrangement or a tandem-O-tandem arrangement based on a reference spindle bearing by a factor in the range of 0.5 up to 0.85, which means that the speed limit is reduced multiplied by this factor. The more individual angular contact ball bearings are used within the entire bearing arrangement and the higher the selected bias class (light, medium, heavy), the greater the reduction can be.

In addition to the reduced speed suitability, unplanned collisions between tool and workpiece are also among the most common causes of failure of machine tool spindles. Due to the limited load-bearing capacity of the spindle bearings or the angular contact ball bearings, unexpected collisions result in high impact loads, which can lead to the balls being plastically deformed due to the small contact area, i.e., the point contact and the resulting high surface pressures on the raceways, and as a result the complete spindle bearing has to be replaced.

As described, angular contact ball bearings are used for the spindle bearing due to their good speed suitability. Tapered roller bearings, on the other hand, are not used in the area of extremely high-speed spindle bearing arrangements with speeds of several thousand rpm up to speeds of well over 10,000 rpm, not least because of the comparatively high frictional torque; they are usually used in classic areas of application with high radial and axial loads and used in a medium speed level. Nevertheless, the usability of tapered roller bearings in the area of high-speed bearings with an n·dm value of 500,000-1,000,000 or higher would be desirable. A speed parameter is defined via the n·dm value, which is calculated from: n·(D+d)/2, where n=speed at the operating point, D=outside diameter of the bearing, d=bore inside diameter of the bearing.

### SUMMARY

The object of the disclosure is therefore to devise a tapered roller bearing suitable for high-speed bearings.

To meet this objective, according to the disclosure it is provided that a tapered roller bearing of the aforementioned type have a nominal contact angle is between 20° and 30° and the tapered rollers have a ratio of rolling element length to rolling element diameter of 1.0-1.2.

It has been found that tapered roller bearings which are designed in the manner described with regard to the nominal contact angle and the ratio of rolling element length to rolling element diameter can be used for such high-speed applications.

By setting the nominal contact angle between 20°-30°, the requirement for a sufficient minimum rigidity of the tapered roller bearing is met, whereby the tapered roller bearing can of course also be biased and the system rigidity can be further improved via the respective bias. The axial and radial rigidity with regard to the high-speed arrangement for mounting tool spindles can therefore be adjusted accordingly via this nominal contact angle.

In today's tapered roller bearings, the rolling friction that arises between the raceway contacts under elastohydrodynamic lubrication has the greatest influence on the total frictional moment, since the majority of the forces are transmitted via the rolling contact. In order to reduce the degree of rolling friction, but at the same time ensure a sufficiently high load-bearing capacity, the tapered rollers used according to the disclosure have a specific ratio of rolling element length to rolling element diameter of 1.0-1.2, that is, the tapered roller becomes practically “square” as the value of the ratio decreases. At a ratio of 1.0, the tapered roller is “square,” since in this case the length of the tapered roller, measured on the thick and thin face, is equal to the rolling element diameter, measured on the thick end of the roller. If the ratio is >1.0, the respective tapered roller is slightly longer than the rolling element diameter. By a corresponding reduction of these tapered roller dimensions or adjustment of the ratio, which for conventional tapered rollers with comparable size of tapered roller bearings for comparable uses is around 2, and consequently these conventional tapered roller bearings have a much higher total friction power, the rolling friction and thus the total frictional torque can be greatly reduced, which enables use for high-speed applications, since rolling friction is no longer the factor that reduces use solely to medium speed ranges.

This means that the combination according to the disclosure of the nominal contact angle limited to the specified interval and the ratio limited to the specified interval, on the one hand, proposes a very rigid, highly load-bearing tapered roller bearing with a greatly reduced rolling resistance, both in the radial and in the axial direction a corresponding bias with regard to the bearing rigidity as well as a corresponding, suitable profiling of the raceway surface and/or the tapered roller surface, which can be made convex, can be further improved.

In further specification, the nominal contact angle interval can be between 22°-28°, in particular between 24°-26°. A particularly useful nominal contact angle is preferably 25°.

In a further development, the interval between the ratio of the length of the rolling element to the diameter of the rolling element can be between 1.02 and 1.1, with the ratio value preferably being intended to be as small as possible. A particularly preferred ratio of rolling element length to rolling element diameter at the thick end of the roller is 1.04.

A tapered roller bearing usually has corresponding guide ribs that delimit the inner ring and outer ring raceways. During operation, the roller end faces can come into contact with a guide rim. In this contact, there is a superposition of rolling and sliding movement. In order to not expose any of the contact partners to excessive wear in this area, in which there is boundary or mixed friction between the two contact partners, the friction also leading to inadmissibly high bearing heating, an advantageous further development provides for the internal and to provide the outer ring raceways and/or the tapered rollers with a wear protection coating, this wear protection coating also having a friction-reducing effect at the same time. It is sufficient to cover only one of the contact partners, i.e., either the rings or the tapered rollers, with such a wear protection coating. This protects the contact partners when there is contact between the roller face and the guide rim, but at the same time also reduces the level of friction.

A wear protection coating based on carbon and hydrogen and optionally containing integrated nanoparticles in the form of a nitride, boride, carbide, or silicide can be provided as such a wear protection coating. Such a wear protection coating is used, for example, under the brand names “TriondurC+” and “TriondurCX+” by the applicant, Schaeffler Technologies AG & Co. KG; in addition, such a wear protection coating is described, for example, in the applicant's patent application DE 10 2006 029 415 A1, the content of which is fully incorporated herein with regard to the wear protection coating.

In a further development, one or more bores permitting a lubricant entry into the rolling bearing area, in particular on a rim of the inner or outer ring, can be provided on the inner and/or outer ring. A lubricant supply to the critical points in the rolling area is possible via this one, preferably several, lubricant bores. Since such an area is the contact area between the roller face and the guide flange, the lubricant bores are preferably bound to the guide flange.

Overall, the roller bearing according to the disclosure enables the use of such tapered roller bearings in high-speed applications such as, in particular, tool spindle bearings, especially with maximum design in terms of nominal contact angle, ratio of rolling element length to rolling element diameter, wear protection coating and lubricant bores. Due to the high axial and radial rigidity of the tapered roller bearings, there is the possibility of replacing the conventional tapered-tapered ball bearing pairs with a single tapered roller bearing. On the one hand, such a tapered roller bearing has a significantly higher radial and axial rigidity and thus a higher load rating than an angular contact ball bearing or an angular contact ball bearing tandem, with the higher radial and axial rigidity in particular having a positive effect on lower shaft displacement and load on the tool shaft. On the other hand, there is also a lower surface pressure compared with angular contact ball bearings due to the line contact, which leads to a longer service life, that is, the tapered roller bearings are less sensitive to load and speed compared with angular contact ball bearings. An almost constant friction in the entire load spectrum also contributes to this, with the friction being significantly reduced on the one hand by the almost “square” design of the tapered roller geometry according to the disclosure and on the other hand, if provided, by the use of the wear protection coating, compared with commercially available tapered roller bearings. The tapered roller bearings according to the disclosure also have an almost homogeneous, clean cage kinematics of the cage holding or guiding the tapered rollers.

In addition to the tapered roller bearing itself, the disclosure also relates to a tool spindle arrangement comprising a tool spindle, a housing and several roller bearings supporting the tool spindle in the housing, with tapered roller bearings of the type described above being provided as roller bearings according to the disclosure.

In the case of the tool spindle arrangement according to the disclosure, it is possible to mount the tool spindle in the housing only via two axially spaced apart tapered roller bearings. This means that according to the disclosure, two separate tapered roller bearings can replace the four angular contact ball bearings previously arranged in the usual tandem-O-tandem arrangement (sometimes more than four such angular contact ball bearings are provided), with comparable or even better bearing performance.

### BRIEF DESCRIPTION OF THE DRAWINGS

The disclosure is explained below on the basis of exemplary embodiments with reference to the drawings. The drawings are schematic representations, wherein:

FIG. 1 is a schematic diagram, in section, of a tapered roller bearing according to the disclosure,

FIG. 2 is a basic illustration of a tool spindle arrangement according to the disclosure, and

FIG. 3 is a tool spindle arrangement according to the prior art.

### DETAILED DESCRIPTION

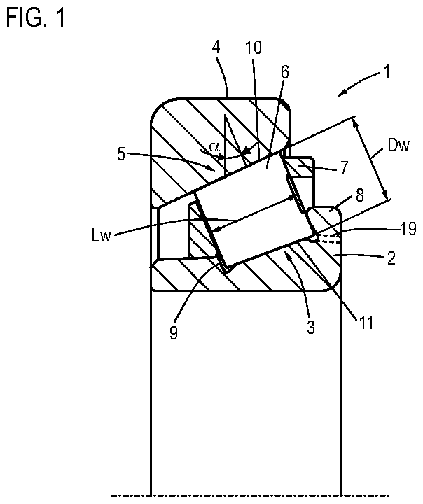

FIG. 1 shows a tapered roller bearing 1 according to the disclosure in a sectional view. The tapered roller bearing 1 comprises an inner ring 2 with an inner ring raceway 3 and an outer ring 4 with an outer ring raceway 5. Tapered rollers 6, which are guided in a cage 7, roll on the raceways 3, 5. The tapered rollers 6 are guided over two rims 8, 9 formed on the inner ring 2.

The two raceways 3, 5 are each provided with a wear protection coating 10, 11, which at the same time has friction-reducing properties. For this purpose, for example, a wear protection coating, as described in DE 10 2006 029 415 A1 or used by the applicant under the brand name “TriondurC+” or “TriondurCX+”, can be used.

The tapered rollers 6 have a specific geometry in terms of the ratio of rolling element length Lw to rolling element diameter at the thick roller end Dw. FIG. 1, on the one hand, shows the rolling element length Lw, which is defined by the thin and thick roller end face. The rolling element diameter Dw is determined at the position of the thick end of the roller. The ratio of Lw/Dw is 1.0-1.1, preferably 1.02-1.1 and in particular 1.04. This means that the rolling element length Lw is approximately equal to the rolling element diameter Dw; a ratio as close as possible to 1.0 is preferred.

In addition, a specific nominal contact angle α is provided, which is between 20°-30°. The nominal contact angle is preferably between 22°-28°, in particular between 24°-26° and in particular 25°.

An extremely high axial and radial rigidity is formed via the nominal contact angle α, if necessary in conjunction with a corresponding bias of the tapered roller bearing 1. By choosing the ratio Lw/Dw provided according to the disclosure, the rolling friction or the overall friction of the tapered roller bearing 1 is greatly reduced, with the wear protection coatings 10, 11 being additionally conducive to this reduction in friction. Overall, the result is a high load-bearing, axially and radially very rigid, tapered roller bearing with a very low surface pressure resulting from the ratio Lw/Dw, which is insensitive to load and speed and has very low friction compared with previously known tapered roller bearings. Therefore, the tapered roller bearing according to the disclosure is suitable for use in high-speed bearing applications.

As is also shown by the dashed lines in FIG. 1, one or more bores 19 which allow lubricant to enter the rolling area can be provided, which bores are preferably formed on a rim 8, 9. Via these bores 19, lubricant can directly enter the rolling area and in particular the rim area where the end faces of the tapered rollers 6 run against the respective rim 8, 9.

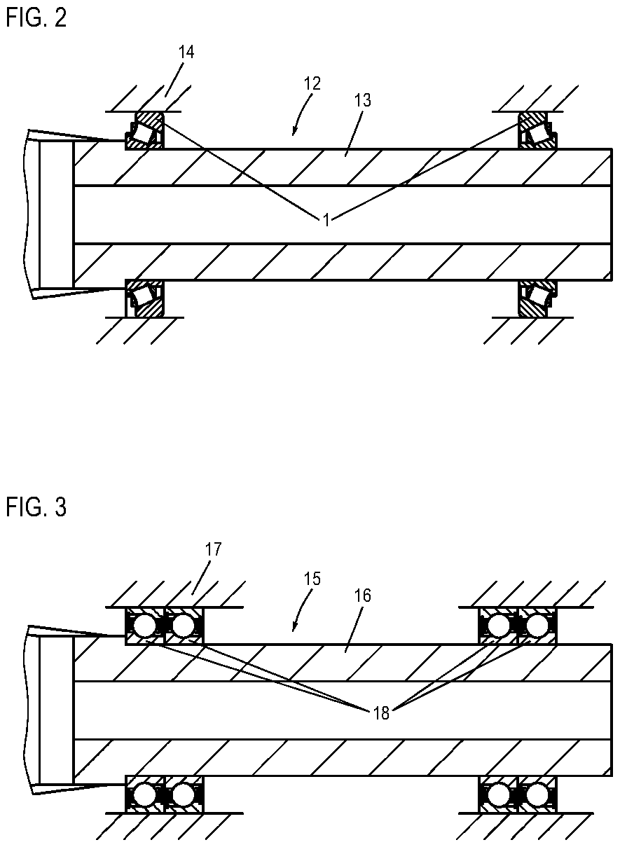

Such a high-speed bearing arrangement according to the disclosure in the form of a tool spindle arrangement 12 according to the disclosure is shown in FIG. 2. A tool spindle 13 is shown, which is supported in a housing 14, which is only suggested here, by two tapered roller bearings 1 according to the disclosure, which are positioned here in an O-arrangement. Due to the properties described above, in particular with regard to the high load rating, the high radial and axial rigidity and the relatively low friction, it is possible to mount such a tool spindle 13 with only two tapered roller bearings 1 instead of providing several angular contact ball bearings as was previously the case.

An example of such a tool spindle arrangement according to the prior art is shown in FIG. 3. The tool spindle arrangement 15 shown there also has a tool spindle 16 which is mounted in a housing 17, wherein four angular contact ball bearings 18 are used, which are installed in a tandem-O-tandem arrangement. Two angular contact ball bearings 18 each form a pair, that is, a tandem, the angular contact ball bearings 18 being arranged identically within the pair by the arrangement of the contact angle, but the two pairs are positioned in an O arrangement. Since with such a spindle bearing, which requires four angular contact ball bearings 18, due to the large number of angular contact ball bearings 18, there is a considerable reduction in the speed limit, the use of only two tapered roller bearings according to the disclosure instead of four (or more) angular contact ball bearings is of particular advantage, since with fewer components, namely only two tapered roller bearings, comparable or even better bearing properties can be achieved.

### LIST OF REFERENCE SYMBOLS

1 Tapered roller bearing
2 Inner ring
3 Inner carrier
4 Outer ring
5 Outer ring raceway
6 Tapered rollers
7 Cage
8 Rim
9 Rim
10 Wear protection coating
11 Wear protection coating
12 Tool spindle arrangement
13 Tool spindle
14 Housing
15 Tool spindle arrangement
16 Tool spindle
17 Housing
18 Angular contact ball bearings
19 Bore

1. A tapered roller bearing, comprising:
an inner ring with an inner ring raceway;
an outer ring with an outer ring raceway; and
tapered rollers rolling on the raceways;
wherein a nominal contact angle is between 20°-30° and the tapered rollers have a ratio of rolling element length to rolling element diameter of 1.0-1.2.

2. The tapered roller bearing according to claim 1, wherein the nominal contact angle is between 22° and 28°.

3. The tapered roller bearing according to claim 2, wherein the nominal contact angle is 25°.

4. The tapered roller bearing according to claim 1, wherein the ratio of the rolling element length to the rolling element diameter is 1.02-1.1.

5. The tapered roller bearing according to claim 4, wherein the ratio of the rolling element length to the rolling element diameter is 1.04.

6. The tapered roller bearing according to claim 1, wherein at least one of the inner and outer ring raceways or the tapered rollers are provided with a wear protection coating.

7. The tapered roller bearing according to claim 6, wherein the wear protection coating is carbon and hydrogen based.

8. The tapered roller bearing according to claim 1, further comprising one or more bores on at least one of the inner or the outer ring configured to allow lubricant entry into a rolling area.

9. A tool spindle arrangement comprising:
a tool spindle;
a housing; and
several of the tapered roller bearings according to claim 1 supporting the tool spindle in the housing.

10. The tool spindle arrangement according to claim 9, wherein the tool spindle is only supported in the housing via two axially spaced-apart ones of the tapered roller bearings.

11. The tapered roller bearing according to claim 7, wherein the wear protection coating includes integrated nanoparticles formed of a nitride, boride, carbide, or silicide.

12. The tapered roller bearing according to claim 8, wherein the bores are located on a rim of the inner or outer ring.

13. A tapered roller bearing, comprising:
an inner ring with an inner ring raceway;
an outer ring with an outer ring raceway;
tapered rollers rolling on the raceways; and
a cage that retains the tapered rollers
wherein a nominal contact angle is between 20°-30° and the tapered rollers have a ratio of rolling element length to rolling element diameter of 1.0-1.2.

14. The tapered roller bearing according to claim 13, further comprising one or more bores on at least one of the inner or the outer ring configured to allow lubricant entry into a rolling area.

15. The tapered roller bearing according to claim 14, wherein the bores are located on a rim of the inner or outer ring.

16. A tool spindle arrangement comprising:
a tool spindle;
a housing; and
several of the tapered roller bearings according to claim 13 supporting the tool spindle in the housing.

17. The tool spindle arrangement according to claim 16, wherein the tool spindle is only supported in the housing via two axially spaced-apart ones of the tapered roller bearings.
